(19) United States
(12) Patent Application Publication
(10) Pub. No.: US 2023/0167909 A1
(43) Pub. Date: Jun. 1, 2023

(54) A GAS VALVE WITH ROTATING DISC MEMBER

(71) Applicant: TURAS GAZ ARMATURLERI SANAYI VE TICARET A.S., Silivri/lstanbul (TR)

(72) Inventor: Gokhan Turhan, Silivri/Istanbul (TR)

(21) Appl. No.: 17/921,885

(22) PCT Filed: Apr. 30, 2020
(86) PCT No.: PCT/TR2020/050361

§ 371 Date: Oct. 27, 2022

(51) Int. Cl. F16K 3/08; F16K 3/36; F23N 1/00

(52) U.S. Cl. CPC F16K 3/08; F16K 3/36; F23N 1/007; F23N 2235/16; F23N 2235/24

(57) ABSTRACT

The invention relates to a gas valve unit, comprising a valve body surrounding an inner chamber in a sealing manner; an inlet part; at least one gas outlet in connection with the inner chamber to conduct gas via an outlet channel; a stationary disc member dividing the inner chamber; a rotating control disc member which is superimposed on a corresponding rear wall of the stationary disc member from an inner wall and mounted on a lower part which extends into the inner chamber of a control rod extending out from the body; also an elongated cavity formed in the inner wall of the control disc member and aligned to direct the gas flow to the through hole in an operational position.

### TECHNICAL FIELD

The invention relates to adjustable gas regulating valves for controlling the gas flow rate via control elements having the structure of the rotatable disc.

### BACKGROUND OF THE INVENTION

The gas regulating valve units are ready-to-install units in household or outdoor appliances are provided between a burner and a gas supply. Gas valve units generally operate by rotating a control rod attached to the body by means of a rotary knob. Angular position of the knob determines the gas flow rate that the gas regulating valve limits.

WO2018216044A gas valve unit comprising a body provided with an inlet, fluidically connectable to a gas source and to at least one outlet, a main chamber, defined at least in part in said body, put into fluid communication with said gas inlet and provided with main outlet hole put into fluid communication with said outlet, a disc-shaped element which is housed in said main chamber, is provided with at least one through opening defining at least two zones, having a mutually different passage section in order to put said main chamber into communication with said main outlet hole.

### SUMMARY OF THE INVENTION

The object of the invention is to increase the burning efficiency in the gas regulation valve for domestic cooking appliances in which the gas flow rate is regulated via a stationary disc member.

In order to achieve abovementioned objects, the invention includes a gas regulating valve unit for a household cooking appliances, comprising a valve body surrounding an inner chamber in a sealing manner; an inlet part disposed in the valve body and providing gas flow towards the inner chamber; at least one gas outlet in connection with the inner chamber to conduct gas via an outlet channel; a stationary disc member having a through hole opening into the outlet channel and dividing the inner chamber to direct the gas flow reaching the inner chamber through a front wall towards the through hole; a rotating control disc member which is superimposed on a corresponding rear wall of the stationary disc member from an inner wall and mounted on a lower part which extends into the inner chamber of a control rod extending out from the body such that in a closed position it blocks gas flow to the through-hole and makes it accessible in an operational position. The gas regulating valve unit further includes an elongated cavity formed at the inner wall of the control disc member and alignedradially at least partially overlapping the through hole to direct the flow of gas fed from the inner chamber in an operational position. In this case, in operational position while the gas flow supplied from the inlet opening to the inner chamber is forced to transfer from the passage opening to the outlet channel by the stationary disc member that divides the inner chamber by passing through the movable disc member channel, the cross-sectional area where the channel and the passage opening overlap can be changed by turning the movable disc member and the flow rate can be adjusted. Unlike a through hole, the channel does not form a blockage when external elements such as an oil film between the inner wall and the rear wall pass due to their rotation on each other during adjustment. This has provided a long-lasting gas regulating valve unit.

In a preferred embodiment the cavity is in a spiral-like form, wherein it is arranged such that the cross-sectional area aligned with the through hole becomes narrow by the rotational movement of the control disc member. The spiral-like form allows the cavity to be extended in a rotational manner on the inner wall. Thus, by turning the control rod and rotating the control disc member, infinite flow rate regulation depending on the cross-sectional area change can be made ergonomically, by means of the elongated cavity, for example, by turning 270° in the radial direction.

A preferred embodiment of the invention includes a central mounting hole that reaches from a front end of the cavity to the inlet section to provide gas transmission and is opened from one end to the other with the control rod extending. The central mounting hole, on the one hand, takes the gas from the inlet and delivers it to the cavity, on the other hand, it allows the control rod to move both in the rotational direction and linearly within the movable disc member. In an alternative embodiment, it may be possible to transfer the gas from the inlet to the cavity with another hole structure disposed at the center of rotation, which does not reach the control rod.

In a preferred embodiment of the invention, the depth of the cavity is arranged so that it decreases from a front end that first reaches the through hole in the radial direction to an opposite rear end. Thus, the flow rate can be adjusted to decrease in the radial direction not only according to the cross-sectional area but also to the depth of the cavity. In alternative embodiments, it is possible to form the recess depth in different structures, for example increasing and decreasing, rather than continuously decreasing. By making the gas flow rate a parameter for regulation thereof, it is possible to configure the gas regulating valve unit to transfer different gas flow rates with rotation.

In a preferred embodiment of the invention, the width at the front end of the cavity is essentially equal to or greater than the through hole width. Thus, when the movable disc member is rotated, the part that provides the most gas cross-sectional area overlaps with the through hole. Thereby, it is possible to transfer the maximum gas flow rate to the gas through hole in the first stage.

In a preferred embodiment of the invention, the front end and the rear end in the opposite direction of the cavity are arranged so that the cross-sectional area decreases linearly in the direction of rotation. The reduction of the cross-sectional area provides a linear decrease in the flow from the front end to the rear end and thus allows the user to change the gas flow rate proportionally with the angle of rotation of the control rod.

In a preferred embodiment of the invention, the inner wall of the control disc member and the corresponding stationary disc member have an even and flat form with the adjacent rear wall extending perpendicular to the axis of the control rod. Thereby, oil can be applied between the control disc member and the stationary disc member to form an oil film therebetween, and a mutual continuous contact surface structure suitable for radial movement is obtained. In a possible embodiment, it is also possible to construct the inner wall and the rear wall in a stepped form that engages each other and does not contain any obstructions in the radial direction.

In a preferred embodiment of the invention, the control disc member and the outer periphery of the stationary disc member are aligned with each other. In this way, ease of assembly and disassembly is provided by placing and removing it in an inner room of equal width.

In a preferred embodiment of the invention, the outer wall of the control disc member includes a truncated cone-like form. A compact control disc member is obtained which can be used in existing gas regulating valve units with its truncated cone form, extends outwards for functional purposes and takes up less space.

In a preferred embodiment of the invention, the control disc member includes an adapter socket in the form of a slot provided at the top and adjusted perpendicular to the extension axis of the control rod. It becomes possible to apply torque to the control disc member with a piece placed in the adapter socket.

In a preferred embodiment of the invention, the control disc member includes a plurality of lubrication channels that are distributed along the inner wall and adjacent to the cavity and formed shallowly. The lubrication channels allow to form an oil film by releasing the stored oil with the rotational movement between the inner wall and the rear wall. In a possible embodiment, it is possible for the lubrication channel to be formed on the rear wall or opposite the inner wall of the stationary disc member.

In a preferred embodiment of the invention, gaskets are used to provide sealing between gas passage channels. The mechanical compression of the said gasket takes place by the pressure on the stationary disc member by means of the tabs of the tab-shaped cover attached to the body. Thereby, sealing is ensured by taking the form of the gasket. A preferred embodiment includes a cover which is hermetically mounted to the body by pressing from one of its ends to the control rod from the upper part and from the other one of its ends by mechanically compressing a gasket surrounding the through hole on the rear wall by means of a tab thereon, towards the inner chamber.

In a preferred embodiment of the invention, the stationary disc member is provided in a flat form and includes a segmented grip part on an outer periphery that is arranged to prevent rotation in the inner chamber. The grip part ensures that the flat-shaped stationary disc member remains in a fixed position by creating resistance against the forces in the direction of rotation after it is divided into the inner chamber.

In a preferred embodiment of the invention, the grip part is in the form of a radial projection provided at the periphery of the stationary disc member and engaging a corresponding retaining wall in the inner chamber. By forming the outer part of the stationary disc member in the form of a radial projection, a body structure that fits into the retaining wall is easily produced.

A preferred embodiment of the invention includes a gas range or heating device to which a gas valve unit described above is adapted.

### BRIEF DESCRIPTION OF THE DRAWINGS

FIG. 1 is a bottom perspective view of a representative embodiment of the gas regulating valve of the invention, with the inner chamber visible.

FIG. 2 is a perspective view of a stationary disc member used in the gas regulating valve with the gasket removed from its inner wall.

FIG. 3 is a perspective view from the front wall of a movable disc member configured in accordance with the stationary disc member in FIG. 2.

FIG. 4 is a schematic representation of a pair of fixed and movable disc members in the gas-off position.

FIG. 5 is the left side view of a representative embodiment of the gas valve of the invention with the gas flow rate set at maximum.

FIG. 6 is the GG sectional view of the gas valve shown in FIG. 5.

FIG. 7 is the AA sectional view of the gas valve shown in FIG. 6.

FIG. 8 is the HH sectional view of the gas valve shown in FIG. 5.

FIG. 9 is a perspective view of a representative embodiment of the body of the gas valve showing the inner chamber.

FIG. 10 is an inside perspective view of a representative embodiment of the cover of the gas valve.

### DETAILED DESCRIPTION OF THE INVENTION

In this detailed description, the development of the invention has been described without any limitation and only with reference to the examples for a better explanation of the subject.

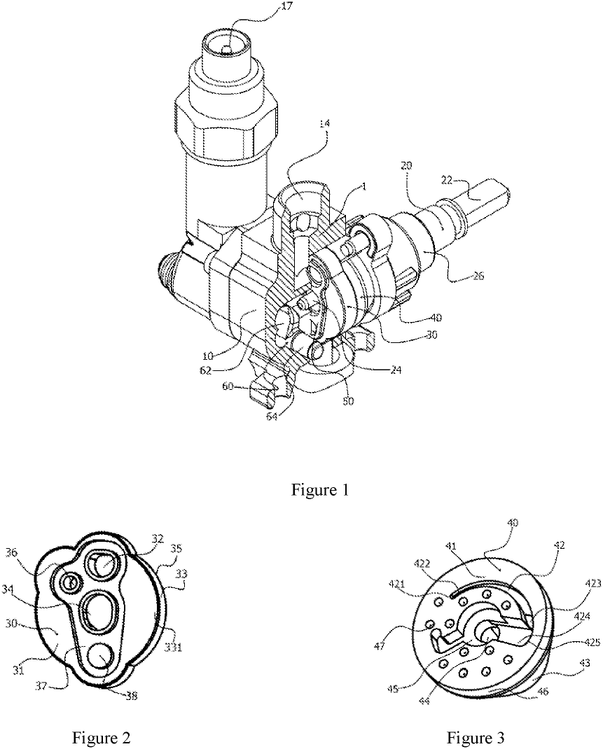

In FIG. 1, a representative embodiment of the gas valve unit of the invention in assembly is shown in perspective view. The gas valve unit has a structure in which a flammable gas (e.g. natural gas) is transferred from an inner chamber (1) sealed by a metal body (10) shown in FIG. 9 to form a gas flow with an adjustable flow rate. The body (10) has segmented structure and the parts are sealed tightly to each other with gasket connections. An upper part (22) of the control rod (20) attached to the body (10) from the front, extends from its free end to the inner chamber (1) so that it rotates around its own axis by being connected to a control knob (not shown). A lower part (24) of the control rod (20), which is movably connected with the upper part (22) of the control rod, extends to a safety assembly (60) disposed at the end of the inner chamber (1). The safety assembly (60) comprises a shaft (64) pivotally articulated in the axial direction in the inner chamber (1) in a position perpendicular to the control rod (20). The shaft (64) is mounted on the body (10) from its distal end. At the proximal end of the shaft (64), there is a radial outward extending tab (62). The end of the tab (62) contacts the lower part (24) of the control rod (20).

A stationary disc member (30) is fixed perpendicular to the control rod (20) against axial and rotational movements in the inner chamber (1) so as to transversely divide the inner chamber. The stationary disc member (30) has an even and flat form and fits from a segmented convex outer periphery (33) to the retaining wall (18) with corresponding concave recesses surrounding the inner chamber (1). A front wall (35) parallel to and opposite to a rear wall (31) of the stationary disc member (30) and a control disc member (40) from one inner wall (41) are overlapped. An outer wall (43) of the control disc member (40) extends outward in a conical structure such that it valveers. A sealing gasket (50) is placed on the rear wall (31) of the stationary disc member (30). The gasket (50) completely surrounds the auxiliary hole (36), which is longitudinally drilled, by means of a through hole (34) of the stationary disc member (30), respectively, and a through hole (32) at an angular distance aligned around thereof.

The body (10) has a gas inlet part (12) and a gas outlet (12) associated therewith to selectively transmit fluid. The inlet part (12) and the gas outlet (14) have a cylindrical form and form a passage path for the gas flow. In addition, a safety outlet (17) parallel to the gas outlet (12) is connected to the inner chamber (1) on the body (10) so as to provide gas transmission.

In FIG. 2, the one-piece stationary disc member (30) is shown in perspective from its rear wall (31). The stationary disc member (30) in the form of a flat plate with an outer periphery (33) formed by dividing the surroundings thereof with adjacent handle parts (331), has a channel (37) opened on its flat rear wall (31). The rubber gasket (50) corresponding to the channel (37) fits tightly. A circular central hole (34) is cut in the center of the stationary disc member (30). Adjacent to this, there is a block (38) surrounded by the channel (37). The block (38) is in the form of a circular projection. The through hole (32) adjacent to the central hole (34) in the opposite direction to the block (38) is in an elongated form in the radial direction. The auxiliary through hole (36) is provided on the stationary disc member (30) as being adjacent to the through hole (32) adjacent to the central hole (34). The auxiliary through hole (36) is circular and has a small area than the through hole (32). The center hole (34), the through hole (32) and the auxiliary through hole (36) are extended from the channel (37) to the rear wall (31) with a flue part extending along the depth of the channel (37).

In FIG. 3, the one-piece ceramic rotating disc member (40) is shown in perspective from the inner wall (41) thereof. The controlling disc member (40) is in the form of a truncated cone and its wide circular part forms the planar inner wall (41) thereof. In the center of the inner wall (41) there is a mounting hole (44) that is drilled from one end to the other. The mounting hole (44) has an expansion chamber (45) which is gradually and radially enlarged towards the inner wall (41). A side portion of the expansion chamber (45) includes a spirally extending recess (42) in the inner wall (41) at radial distance to the mounting hole (44). The cavity (42) runs radially in the inner wall (41) with increasing width and depth, starting from a rounded rear end (421) forming a narrow portion (422) and extends continuously from a front end (424) through a wide part (423) that joins the expansion chamber (45) to the mounting hole (44) so as to provide gas transmission. At the junction of the expansion chamber (45) and the front end (424), the expansion chamber (45) leads through a passageway to a baffle wall (425), which is the outer part of the front end (424). The cavity (42) is provided adjacent and at a distance with a circular outer periphery (46) of the inner wall (41). An L-like auxiliary channel extends from one end of the front end (424) to the expansion chamber (45) at a wide angle. Multiple lubrication channels (47) are opened in the inner wall (41) that form a lubricating channel in a multiple hemispherical structure distributed in planar sections. The lubrication channels (47) are distributed on the inner wall 41 along the radial line delimited by the cavity (42).

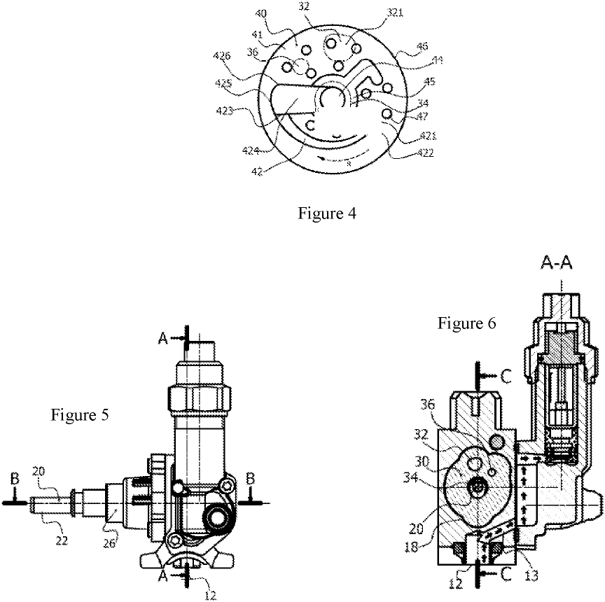

In FIG. 4, the gas valve unit is schematically shown in the closed position, with the stationary disc member (30) aligned on the inner wall (41) of the control disc member (40). The control disc member (40) is placed concentrically on the stationary disc member (30). The inner wall (41) of the control disc member (40) overlaps the front wall (35) of the stationary disc member (30). In the closed position, the cavity (42) is blocked by a flat portion of the front wall (35). On the other hand, the mounting hole (44) is coaxial with the center hole (34) and is opened to allow gas passage to each other. The spiral-shaped cavity (42) is spaced radially at an accessible 90° angle, with its front end (424) facing the through hole (32). The cavity (42) extends radially outward from the expansion chamber 45 to reach the baffle wall (425) and wherein it decreases in both cross section and depth from the wide portion (423) to the opposite rear end (421) where the narrow portion 422 is disposed. Since the control rod (20) extends axially through a cylindrical passage channel formed by the mounting hole (44) and the center hole (34), the gas flow supplied from the inlet (12) from the distance between the control rod (20) and the passage channel is first taken to the expansion chamber (45), then it hits the baffle wall (425) and proceeds from the front end (424) to the wide part (423), and from there through the cavity (42), which narrows both in width and depth, to the rear end (421). In the closed position, the cavity (42) completely covers the planar portion of the front wall (35) of the stationary disc member (30) in a sealed manner. In the maximum gas position in which the gas is directed to the gas outlet (14) at maximum flow rate, the wide part (423) is aligned with the passage hole (32) completely. In this case, a front edge (426) of the cavity (42) aligns with the through hole (32) and the entire area of the through hole (32) lies within the cavity (42). Thus, the stationary disc member (30) transmits the gas flow to the gas outlet (14) through the through hole (32).

The maximum flow rate state for a gas regulating valve unit configured for use on a gas range is shown in FIGS. 5-8. In FIG. 5, the gas regulating valve unit is shown from the left. Here, the upper part (22) of the control rod (20) extending outward is visible on the body (10). The upper part (22) is mounted to the body (10) under a cover (26) rotating around its axis. The cover (26) shown in FIG. 10 is a hollow conical piece. At least two tabs (28) extend on the wide mouth of the cover (26) facing the body (10), wherein pressure is exerted on the stationary disc member (30) by the forms opened on the body (10) through the face corresponding to the body from the said tabs (28). Thus, sealing is provided by mechanical compression to the gasket (50) positioned on the stationary disc member (30).

In FIG. 6, A-A section is shown on a vertical axis passing through the inlet part (12). The retainer boundary (18) in which the stationary disc member (30) is placed from the outer periphery (33) in the inner chamber (1) has recesses suitable for the handle parts (331). The stationary disc member (30) is placed on the retainer boundary (18) and fixed in the body (10) so as to divide the inner chamber (1). The gas flow (shown by arrows) supplied from the inlet part (12) proceeds through an inlet channel (13) in the body (10) and reaches the inner chamber (1).

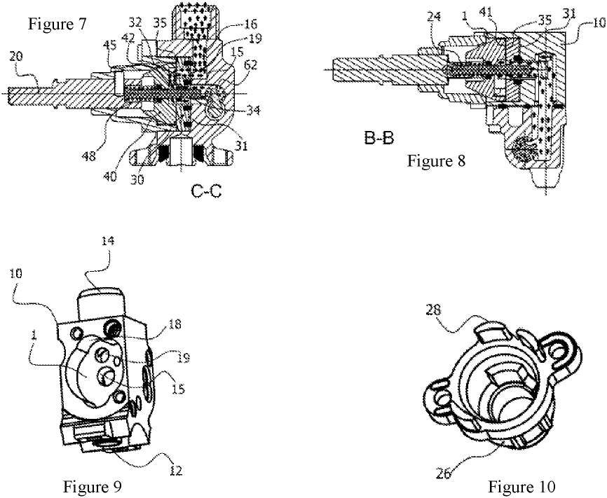

As shown in FIG. 7 in H-H section, by pushing the control rod (20) from the upper part (22) to which the button is attached, the gas flow is started by pushing the tab (62) of the safety assembly (60) through the lower part (24). Meanwhile, the gas from the inlet channel (15) accumulated in the inner chamber (1) first reaches the rear wall (31), then stopped over the stationary disc member (30) and passes through the center hole (34) and reaches the mounting hole (44) of the control disc member (40). The gas flow proceeding to the cavity (42) therefrom through the expansion chamber (45), reaches the stationary disc member (30) again, this time from its front wall (35) adjacent to the cavity (42) and is directed through the wide part (423) of the cavity (42) to the through hole (32) disposed above thereof. The gas flow, which is delivered therefrom to an orifice (19) reaching a gas outlet channel (16), reaches the gas outlet (14).

For regulating the gas flow, the control rod (20) is rotated in its reach axis. The control rod (20) is connected from its upper part to an adapter socket (48) disposed at the front end of the control disc member (40). Thereby, when the control rod (20) is rotated, the control disc member (40) rotates. The wide part (423) of the cavity (42) that reaches to the through hole (32) by turning the control disc member (40) 90° from the closed position shown in FIG. 4, is blocked by the planar part of the front wall (35) while rotating is continuing, and the through hole (32) is aligned with the narrowing section of the cavity (42). In the last step, the narrow part (422) is aligned with the auxiliary through hole (36). The auxiliary through hole (36) has a narrower area than the through hole (32) and is aligned with the narrow portion (422) of the spiral cavity (42) to ensure the minimum gas flow rate.

The section B-B is shown in FIG. 8. As can be seen herein, in the inner chamber (1), first the stationary disc member (30) and then the control disc member (40) are fully abutted from the inner wall (41) to the front wall (35). The stationary disc member (30) provides temporary blocking of the gas flow by partitioning the inner chamber (1) between the channel forming the rear part of the inner chamber (1) in the body (10) from its rear wall (31) and surrounding the control rod (20) from the lower part (24) and the control disc member (40) in the opposite direction.

REFERANCE NUMBERS

| | |
|---|---|
| 1 Inner chamber | 36 Auxiliary through hole |
| 10 Body | 37 Channel |
| 12 Inlet part | 38 Block |
| 13 Inlet channel | 40 Control disc member |
| 14 Gas outlet | 41 Inner wall |
| 15 Inlet channel | 42 Cavity |
| 16 Outlet channel | 421 Rear end |
| 17 Safety outlet | 422 Narrow part |
| 18 Retainer boundary | 423 Wide part |
| 19 Opening | 424 Front end |
| 20 Control rod | 425 Baffle wall |
| 22 Upper part | 426 Front edge |
| 24 Lower part | 43 Outer wall |
| 26 Cover | 44 Mounting hole |
| 28 Tab | 45 Expansion chamber |
| 30 Stationary disc member | 46 Circumferential edge |
| 31 Rear Wall | 47 Lubrication channel |
| 32 Through hole | 48 Adaptor socket |
| 33 Outer periphery | 50 Gasket |
| 331 Grip part | 60 Safety assembly |
| 34 Central hole | 62 Tab |
| 35 Front Wall | 64 Shaft |
| | R Direction of rotation |

1. A gas regulating valve unit for a domestic cooking appliance comprising a valve body surrounding an inner chamber in a sealing manner; an inlet part disposed on the valve body and providing gas flow towards the inner chamber; at least one gas outlet in connection with the inner chamber to conduct gas flow via an outlet channel; a stationary disc member having a through hole having access the outlet channel and dividing the inner chamber so as to direct the gas flow reaching the inner chamber through a front wall towards the through hole; a rotating control disc member superimposed on a corresponding rear wall of the stationary disc member from an inner wall and mounted on a lower part protruding to the inner chamber of a control rod extending outwardly from the body, such that in a closed position blocks gas flow to the through-hole and in an operational position enables access characterized in that an elongated cavity is formed at the inner wall of the control disc member and aligned radially at least partially superimposing the through hole to direct the gas flow fed from the inner chamber in an operational position.

2. The gas valve unit according to claim 1, wherein the cavity is in a spiral-like form arranged such that the cross-sectional area aligned with the through hole becomes narrow by the rotational movement of the control disc member.

3. The gas valve unit according to claim 2, wherein the cavity has access to the inlet portion from a front end to provide gas transmission to a central through mounting hole in which the control rod pass through.

4. The gas valve unit according to claim 2, wherein the depth of the cavity is arranged so that it decreases from a front end that first reaches the through hole in the radial direction to an opposite rear end.

5. The gas valve unit according to claim 1, wherein the width of the cavity at the front end is arranged substantially equal to or greater than the width of the through hole.

6. The gas valve unit according to claim 5, wherein the front end and the rear end in the opposite direction of the cavity are arranged so that the cross-sectional area decreases linearly in the direction of rotation.

7. The gas valve unit according to claim 1, wherein the inner wall of the control disc member and the corresponding stationary disc member has an even and flat form with the adjacent rear wall extending perpendicular to the axis of the control rod.

8. The gas valve unit according to claim 7, wherein the control disc member and the outer periphery of the stationary disc member are arranged to be aligned with each other.

9. The gas valve unit according to claim 7, wherein the outer wall of the control disc member includes a truncated cone-like form.

10. The gas valve unit according to claim 9, wherein the control disc member includes an adapter socket in the form of a slot provided at the top and adjusted perpendicular to the extension axis of the control rod.

11. The gas valve unit according to claim 7, wherein the control disc member includes a plurality of lubrication channels that are distributed along the inner wall and adjacent to the cavity and formed shallowly.

12. The gas valve unit according to claim 1, wherein a cover is mounted to the body in a sealing manner by pressing from one of its ends to the control rod from the upper part and from the other one of its ends by mechanically compressing a gasket surrounding the through hole on the rear wall by means of a tab thereon, towards the inner chamber.

13. The gas valve unit according to claim 1, wherein the stationary disc member is provided in a flat form and includes a segmented grip part on an outer periphery that is arranged to prevent rotation in the inner chamber.

14. The gas valve unit according to claim 12, wherein the grip part has the form of a radial projection provided at an outer periphery of the stationary disc member and engages a corresponding retaining wall in the inner chamber.

15. A gas cooker or heating device with the gas valve unit according to claim 1.
